(19) United States
(12) Patent Application Publication
(10) Pub. No.: US 2015/0300228 A1
(43) Pub. Date: Oct. 22, 2015

(54) REDUCTANT FILL SYSTEM

(71) Applicant: Caterpillar Inc., Peoria, IL (US)

(72) Inventors: Xiaohui Gong, Dunlap, IL (US); Dustin I. Landwehr, Kewanee, IL (US); Brian M. Cole, Peoria, IL (US); Ioan David, Dunlap, IL (US)

(73) Assignee: Caterpillar Inc., Peoria, IL (US)

(21) Appl. No.: 14/753,042

(22) Filed: Jun. 29, 2015

(51) Int. Cl. F01N 3/20; B67D 7/02

(52) U.S. Cl. CPC F01N 3/206; B67D 7/02; F01N 2610/1413

(57) ABSTRACT

A method for delivering a reductant into a reductant tank through a fill conduit associated with the reductant tank is provided. The reductant tank is in selective fluid communication with an external source having a delivery conduit associated therewith. The method includes connecting the delivery conduit of the external source with the fill conduit of the reductant tank. The method also includes operating a valve provided on the delivery conduit in a first configuration. The method includes changing an operation of the valve from the first configuration to a second configuration. The method also includes purging of a portion of the reductant retained in the fill conduit into the external source through the pump assembly based on the second configuration of the valve.

### TECHNICAL FIELD

The present disclosure relates to a reductant fill system, and more particularly to the reductant fill system associated with a machine.

### BACKGROUND

Machines, such as an excavator, may include an aftertreatment system associated with an engine. The aftertreatment system includes a reductant supply system for delivery of a reductant into an exhaust stream exiting the engine. The reductant supply system includes a reductant tank for storing the reductant, a reductant fill conduit, and a reductant delivery conduit. As and when required, the reductant tank may be refilled with the reductant from an external source. In order to re-fill the reductant tank, the reductant fill conduit is fluidly connected to the external source. The reductant from the external source may then be supplied to the reductant fill conduit via a pump in fluid communication with the external source.

However, sometimes after the fill operation is conducted, some quantity of the reductant may be retained within the reductant fill conduit on the machine. Since the reductant is susceptible to freezing in cold environments, for machines operating in relatively cold environments, the reductant contained within the reductant fill conduit may freeze. This may affect an overall performance of the aftertreatment system.

The reductant fill conduits are sometimes electrically heated in order to defreeze the reductant retained therein. However, for large machines, a length of the reductant fill conduit is generally long due to a high mounting position of the reductant tank within the machine. In such cases, providing electrical heating elements along the entire length of the reductant fill conduit may lead to increase in associated costs.

U.S. Published Application Number 2013/0186509, hereinafter the '509 publication, describes a reductant supply system. The reductant supply system includes a reductant tank that is configured to store reductant therein. Further, a receiver is configured to receive a supply of the reductant from an off-board reservoir. The reductant supply system includes a reductant supply line in fluid communication with the receiver. The reductant supply line is configured to provide the reductant to the reductant tank.

In the '509 publication, the purging of the reductant supply line is based on a level of the reductant present within the reductant tank. Accordingly, for reductant purging in the '509 publication a separate pressurized fluid stream and multiple valves are provided. This may occupy space within the machine and may also lead to increased component costs. Hence, there is a need for an improved reductant purging system for the reductant supply line.

### SUMMARY OF THE DISCLOSURE

In one aspect of the present disclosure, a method for delivering a reductant into a reductant tank through a fill conduit associated with the reductant tank is provided. The reductant tank is in selective fluid communication with an external source having a delivery conduit associated therewith. The method includes connecting the delivery conduit of the external source with the fill conduit of the reductant tank. The method also includes operating a valve provided on the delivery conduit in a first configuration. The method further includes supplying the reductant through a pump assembly provided on the delivery conduit to the fill conduit of the reductant tank based on the first configuration of the valve. The method includes changing an operation of the valve from the first configuration to a second configuration. The method also includes purging of a portion of the reductant retained in the fill conduit into the external source through the pump assembly based on the second configuration of the valve.

Other features and aspects of this disclosure will be apparent from the following description and the accompanying drawings.

### BRIEF DESCRIPTION OF THE DRAWINGS

FIG. 1 is a side view of an exemplary machine having a reductant fill system, according to one embodiment of the present disclosure; and

FIG. 2 is a schematic view of the reductant fill system of FIG. 1, depicting a fill operation of the reductant into a reductant tank, according to one embodiment of the present disclosure;

FIG. 3 is a schematic view of the reductant fill system of FIG. 1, depicting a purging operation of the reductant from a fill conduit of the reductant tank, according to one embodiment of the present disclosure; and

FIG. 4 is a flowchart for a method of delivering the reductant into the reductant tank through the fill conduit.

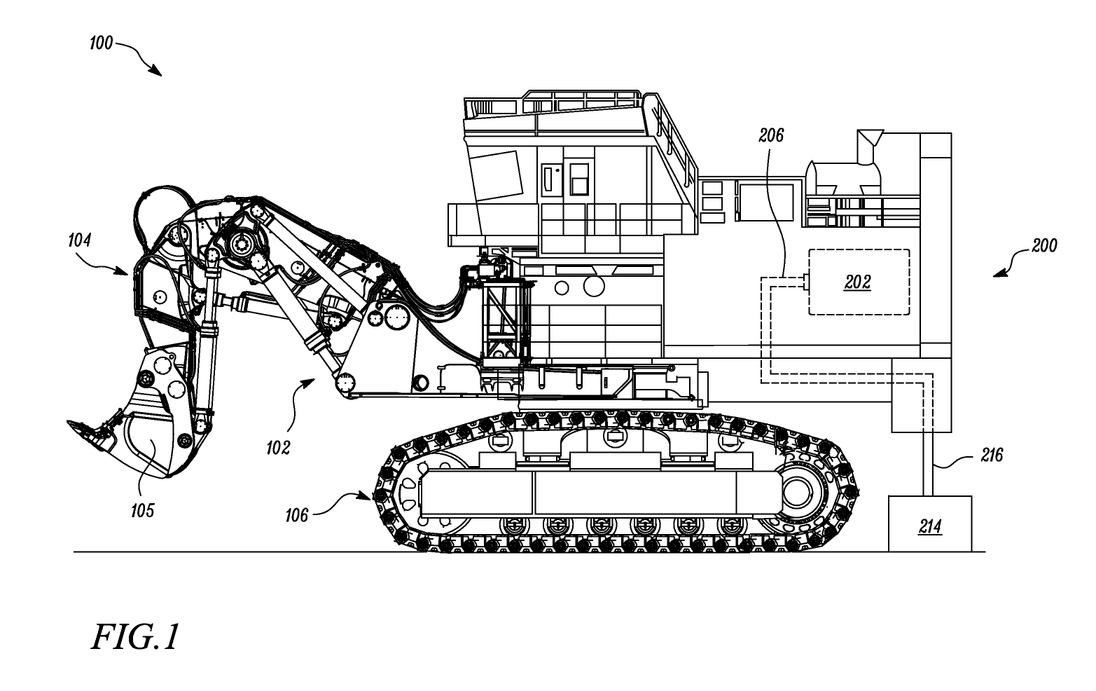

### DETAILED DESCRIPTION

Wherever possible, the same reference numbers will be used throughout the drawings to refer to the same or the like parts. With reference to FIG. 1, an exemplary machine 100 for implementing the present disclosure is depicted. More specifically, the machine 100 is a hydraulic shovel. Alternatively, the machine 100 may be any machine including, but not limited to, a backhoe loader, a wheel loader, an industrial loader, an excavator, a dozer, a mining truck, an articulated truck, a track type tractor, a forklift, a crane, skid steer loaders, compact track loaders, multi-terrain loaders, and so on. The machine 100 may be used in various types of industries such as but not limited to construction, transportation, mining, power generation, and the like.

Referring to FIG. 1, the machine 100 includes a frame 102. The frame 102 includes an implement assembly 104. The implement assembly 104 includes an implement 105 at the end. In the illustrated embodiment the implement 105 is a bucket, in an alternate embodiment the implement 105 may be a blade ripper. The frame 102 is mounted over a ground engaging member 106. In the illustrated embodiment, the ground engaging member 106 includes a pair of tracks provided on either sides of the machine 100. In an alternative embodiment, the ground engaging members 106 may include wheels.

The machine 100 further includes an engine (not shown), which may be an internal combustion engine, such as, a reciprocating piston engine or a gas turbine engine. According to one embodiment of the disclosure, the engine is a spark ignition engine or a compression ignition engine, such as, a diesel engine, a homogeneous charge compression ignition engine, or a reactivity controlled compression ignition engine, or other compression ignition engines known in the art. The engine may be fueled by gasoline, diesel fuel, biodiesel, dimethyl ether, alcohol, natural gas, propane, hydrogen, combinations thereof, or any other combustion fuel known in the art. The engine may include other components (not shown), such as, a fuel system, an intake system, an exhaust system, a drivetrain, and so on.

The machine 100 may further include an exhaust aftertreatment system (not shown). The aftertreatment system is fluidly connected to an exhaust manifold (not shown) of the engine. The aftertreatment system is configured to treat an exhaust gas flow exiting the exhaust manifold of the exhaust system of the engine. The exhaust gas flow contains emission compounds that may include Nitrogen Oxides (NOx), unburned hydrocarbons, particulate matter and/or other combustion products known in the art. The aftertreatment system may be configured to treat or trap NOx, unburned hydrocarbons, particulate matter, combinations thereof, or other combustion products in the exhaust gas flow before exiting the engine.

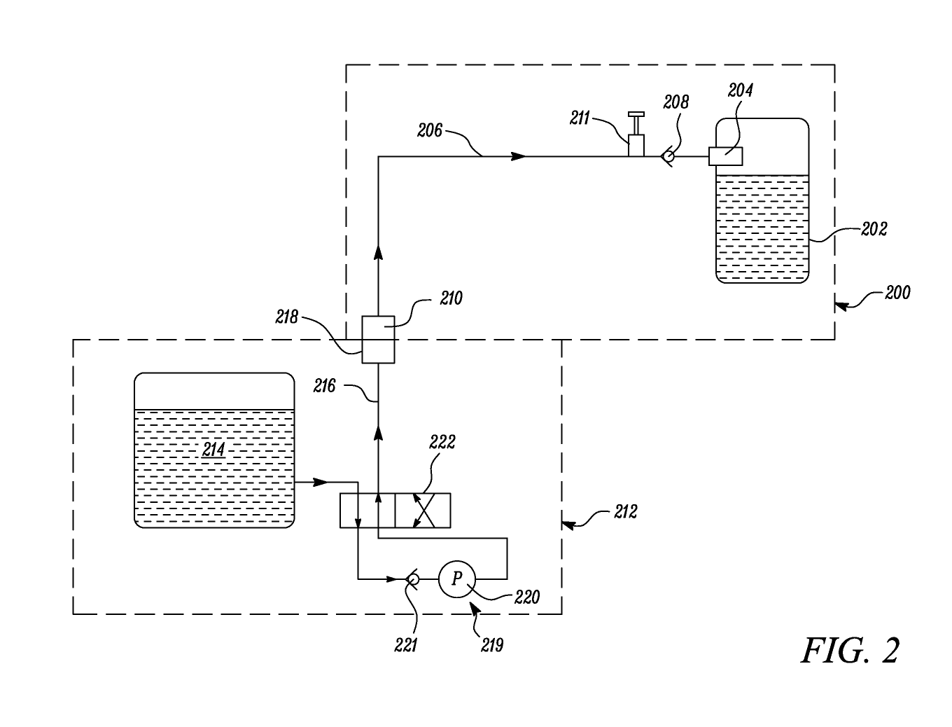

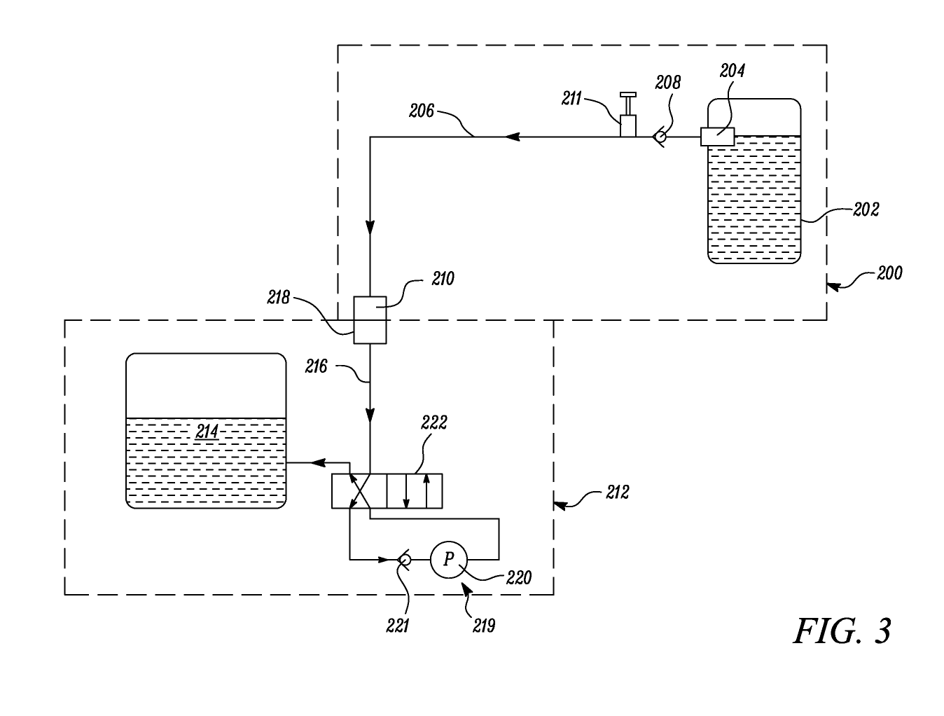

The aftertreatment system includes a reductant supply system 200 (see FIGS. 2 and 3). The reductant supply system 200 is configured to dispense a reductant in the exhaust gas flow exiting the engine. As shown in FIGS. 2 and 3, the reductant supply system 200 includes a reductant tank 202 present onboard the machine 100. The reductant tank 202 is configured to store the reductant therein. The reductant tank 202 is provided in fluid communication with a reductant injector (not shown). The reductant may be a fluid, such as, Diesel Exhaust Fluid (DEF). The reductant may include urea, aqueous ammonia, or other reducing agent known in the art. Parameters related to the reductant tank 202 such as size, location, and material used may vary according to system design and requirements.

The reductant tank 202 includes a level sensor 204. The level sensor 204 is configured to gauge a level of the reductant present within the reductant tank 202. The level sensor 204 may include any known contact or contactless type of level sensing device known in the art, such as a mechanical float. Further, a fill conduit 206 is fluidly coupled to the reductant tank 202 near to a top portion of the reductant tank 202. The fill conduit 206 is configured to allow refilling of the reductant tank 202 with the reductant.

The fill conduit 206 may embody any pipe, tube, hose, and the like made of any one of a metal or a non-metal. The fill conduit 206 includes a one-way valve 208. The one-way valve 208 is configured to allow the reductant to flow in one direction, that is into the reductant tank 202 and block reverse flow of the reductant from the reductant tank 202. Further, a vent 211 is disposed along the fill conduit 206. The vent 211 is configured to selectively introduce air into the fill conduit 206. A receiver 210 is provided at one end of the fill conduit 206.

During a fill operation, the receiver 210 is configured to be coupled to a reductant fill system 212 external to the machine 100. The reductant fill system 212 includes an external source 214 containing the reductant therein. The external source 214 may embody a reservoir or container at ground level. The reductant fill system 212 further includes a delivery conduit 216. One end of the delivery conduit 216 is connected to the external source 214. A nozzle 218 is provided at another end of the delivery conduit 216. The nozzle 218 is configured to connect the delivery conduit 216 to the fill conduit 206 via the receiver 210.

The reductant fill system 212 includes a pump assembly 219 disposed along the delivery conduit 216. The pump assembly 219 includes a pump 220. As shown in FIG. 2, the pump 220 is configured to pump the reductant from the external source 214 into the delivery conduit 216. In one example, the pump 220 may embody a unidirectional hydraulic pump. The pump 220 may include a centrifugal pump or a volumetric pump. The pump assembly 219 includes a one-way valve 221. In some embodiments, the one-way valve 221 may be absent.

The reductant fill system 212 further includes a valve 222. The valve 222 is embodied as a four-way valve. The valve 222 is a flow control valve operating in two configurations. In the first configuration, the valve 222 is configured to allow the filling of the reductant tank 202 (see FIG. 2). Whereas, in the second configuration, the valve 222 is configured to allow the purging of the fill conduit 206 (see FIG. 3). In alternate embodiments, the valve 222 may operate in more than two positions based on operational requirements.

Referring to FIG. 2, during the fill operation, the nozzle 218 of the reductant fill system 212 is coupled with the receiver 210 of the fill conduit 206 by an operator (not shown). In one embodiment, the valve 222 may be manually positioned in the first configuration and the pump 220 may be switched on. In the first configuration, the reductant from the external source 214 flows into the delivery conduit 216 and is introduced into the fill conduit 206. The reductant is then introduced into the reductant tank 202.

In one embodiment, the level sensor 204 may be electronically coupled to a pump controller (not shown), such that the pump 220 may automatically shut off when a level of the reductant in the reductant tank 202 rises above a predetermined threshold. When the pump 220 is in the shut off state, the one-way valve 208 may restrict a backflow of the reductant. Further, pressure may build up within the fill conduit 206. In some examples, the nozzle 218 may be designed such that the nozzle 218 is sensitive to the pressure within the fill conduit 206. In such an example, the pressure build may cause the nozzle 218 to close and obstruct further introduction of the reductant into the fill conduit 206. In another embodiment, the valve 222 may be electronically coupled to the level sensor 204, such that based on the level of the reductant within the reductant tank 202, the valve 222 may be electronically operated to switch to the second configuration. In this case, based on the second configuration of the valve 222, the pump controller may automatically shut off the pump 220.

Some quantity of the reductant may still be retained within the fill conduit 206. In order to purge the reductant retained within the fill conduit 206, the operator may carry out the purging operation of the fill conduit 206. Referring to FIG. 3, during the purging operation, valve 222 is in the second configuration. Further, the vent 211 is opened to allow air to enter into the fill conduit 206. When the pump 220 is switched on, suction is generated in the delivery conduit 216 which causes the air and the reductant retained in the fill conduit 206 to flow towards the external source 214 thereby purging the fill conduit 206. It should be noted that the actuation of the valve 222 between the first and second configurations may be done manually or through a controller. The controller may actuate the valve 222 via an electrical actuator, such as a solenoid, a pneumatic actuator, a hydraulic actuator, or other actuator known in the art.

### INDUSTRIAL APPLICABILITY

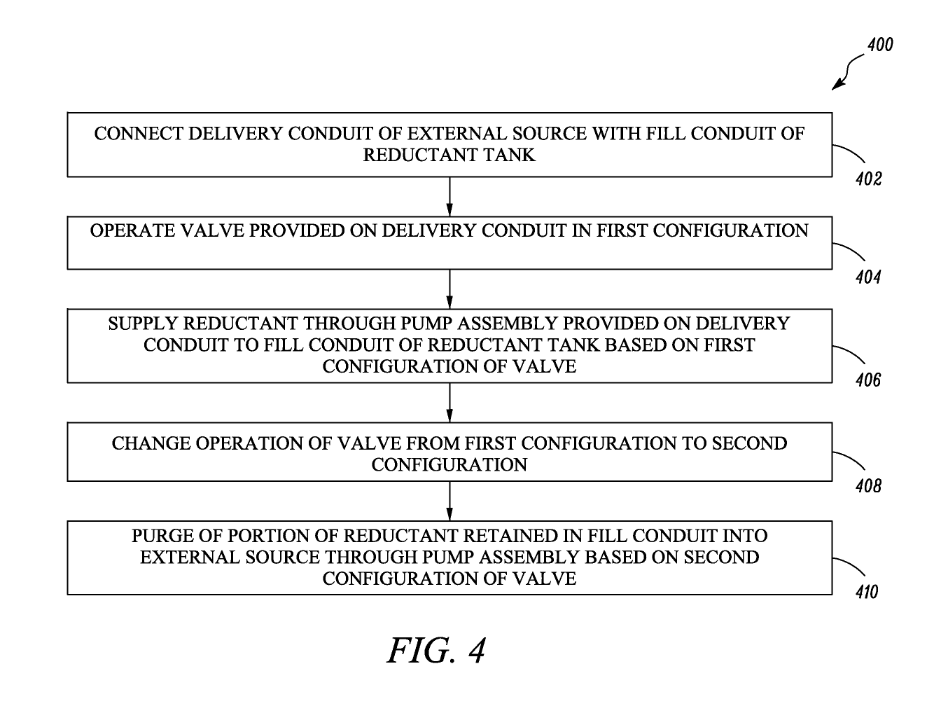

The present disclosure relates to the reductant fill system 212. The reductant fill system 212 allows refilling of the reductant tank 202 and also purging of the reductant retained within the fill conduit 206. FIG. 4 illustrates a method 400 of delivering the reductant into the reductant tank 202 through the fill conduit 206 associated with the reductant tank 202. At step 402, the delivery conduit 216 of the reductant fill system 212 is connected with the fill conduit 206 of the reductant tank 202.

At step 404, the valve 222 provided on the delivery conduit 216 is operated in the first configuration. At step 406, the reductant is supplied to the fill conduit 206 through the pump 220 provided on the delivery conduit 216. At step 408, the operation of the valve 222 is changed from the first configuration to the second configuration. At step 410, the portion of the reductant retained in the fill conduit 206 is purged into the external source 214 through the pump 220.

The present disclosure allows for simplified purging of the fill conduit 206, irrespective of the length of the fill conduit 206. Further, a single four-way valve 222 and pump assembly 219 is used to refill the reductant tank 202, as well as to purge the fill conduit 206. The present disclosure eliminates the requirement of heating elements associated with the fill conduit 206, thereby making the filling and purging operations less complex and costly.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for delivering a reductant into a reductant tank through a fill conduit associated with the reductant tank, wherein the reductant tank is in selective fluid communication with an external source having a delivery conduit associated therewith, the method comprising:
connecting the delivery conduit of the external source with the fill conduit of the reductant tank;
operating a valve provided on the delivery conduit in a first configuration;
supplying the reductant through a pump assembly provided on the delivery conduit to the fill conduit of the reductant tank based on the first configuration of the valve;
changing an operation of the valve from the first configuration to a second configuration; and
purging of a portion of the reductant retained in the fill conduit into the external source through the pump assembly based on the second configuration of the valve.
